(19) United States
(12) Patent Application Publication
(10) Pub. No.: US 2009/0074406 A1
(43) Pub. Date: Mar. 19, 2009

(54) METHOD FOR ALERTING USERS TO CONDITIONS AFFECTING NETWORK SERVICE

(75) Inventor: Michael J. Wurst, Santa Rosa, CA (US)

Correspondence Address: FITZPATRICK CELLA HARPER & SCINTO, 30 ROCKEFELLER PLAZA, NEW YORK, NY, 10112, US

(73) Assignee: Tellabs Petaluma, Inc., Naperville, IL (US)

(21) Appl. No.: 11/856,433

(22) Filed: Sep. 17, 2007

(51) Int. Cl. H04B 10/08

(52) U.S. Cl. 398/25

(57) ABSTRACT

A method to alert users to network service conditions. The method includes detecting a network service condition, detecting an attempt to access at least one communication service of the network, and issuing an alert. A network for practicing the method includes at least one communication terminal and a network element that detects a network service condition, detects an attempt to access a communication service, and issues an alert of the network service condition. A network element operating in the network includes a communications interface, a processor, and a storage device for storing program instructions. The program instructions instruct the network element to detect an attempt to access a communication service and issue an alert of a network service condition. A computer program for controlling the network element includes code to detect an attempt to access a communication service and issue an alert.

### BACKGROUND

1. Field

The present invention relates generally to troubleshooting optical network equipment, and more specifically to an improved method for alerting network service customers to conditions affecting their network service.

2. Description of the Related Art

In the telecommunications industry, network service providers can transmit video, data, and voice information to users of their networks via fiber optic lines linking the service provider and users. In this paradigm, the optical transmission of information occurs via a local loop distribution network, one example of which is a passive optical network (PON). In a typical PON, the optical signal distributed from the central office of the service provider is converted to an electrical signal prior reaching the end user; likewise, electrical communications from users are converted to optical signals for transmission on the optical distribution network.

PONs can be classified according to the location of the optical-electrical conversion. For instance, in a fiber-to-the-node (FTTN) network, the optical-to-electrical conversion occurs at a node in a neighborhood, and users in the neighborhood connect to the node using traditional coaxial or twisted-pair electrical wiring connecting their individual buildings to the node. On the other hand, in a fiber-to-the-premises (FTTP) network, the conversion occurs at the individual user's premises. Other examples include fiber-to-the-business (FTTB), fiber-to-the-curb (FTTC) and fiber-to-the-home (FTTH) networks. These types of networks are herein referred to generally as “FTTx networks.”

In a typical FTTx PON, one or more optical line terminals (OLTs), each of which include one or more passive optical network (PON) cards, are located at a service provider's central office. The OLT couples the FTTx network to the service provider's network. External network services are delivered across the service provider's network to the FTTx network. Signals to and from these external services are processed by the OLT and multiplexed onto a single optical fiber by the PON card. The multiplexed signal passes through an optical distribution network (ODN) to user nodes. Depending on the specific FTTx configuration, the user node may be an optical network terminal (ONT), an optical network unit (ONU), and/or a remote digital terminal (RDT). The user node couples customer premises equipment (CPE) to the ODN and performs the upstream and downstream optical-electrical conversions discussed above.

When a user experiences network service problems, a typical first response may be to attempt to diagnose the problem by checking for faulty connections, evaluating the presence or absence of LED signals on equipment, or consulting equipment manuals. While a user may sometimes be able to solve service problems without assistance from the service provider, often this is not the case, and thus the user seeks assistance from the service provider's operations support systems (OSS). At the OSS, customer service representatives are employed by the service provider to access and interpret alarm telemetry information in order to inform users of the nature of service issues.

However, an OSS has limited personnel and resources available to assist users; any unnecessary user calls to the OSS are costly and inefficient to the service provider. Additionally, the logic required for reconciling telemetry data and alerting users to specific network conditions can be complex. These limitations are magnified when a service issue is located locally in the user's access equipment. In this instance, the OSS is far remote to the condition, i.e., the problem is not local to the central office or the ODN. It can be extremely difficult to diagnose a network problem based solely upon telemetry data from an individual user's access equipment. Even if the OSS manages to diagnose the network problem, the OSS cannot directly repair or fix the condition because the access equipment is remote to the OSS.

As an example, if a user's ONT is physically connected to the network infrastructure but has not been provisioned to communicate with the OLT, the user will not have access to voice, data, or video services. The source of the problem is local to the user's equipment, but most users will not be able to determine on their own the nature of this service problem. Thus, users often will call the OSS. Once the OSS interprets telemetry data, the user will simply be told that their ONT is not provisioned. At this point, both the user and the OSS have spent considerable time diagnosing a problem local to the user's equipment. Perhaps the user can now fix the problem, or perhaps a service technician must visit the user's premises. In either event, human intervention by the OSS was a potentially unnecessary step in fixing the problem and an inefficient use of the service provider's resources.

One approach used to overcome the above limitation is to auto-dial users and report service-related conditions based upon alarm telemetry information received and analyzed by the OSS. While this approach allows users to be informed of service issues, it also informs users of issues independent of whether they are actually using the service. Users will be alerted to all service conditions, even ones that occur while they are asleep, not at home, or otherwise not using the network service. Thus, if there are persistent service issues, users may develop a poor impression of the service provider's service quality.

### SUMMARY

According to an example embodiment of the invention, the method includes detecting a network service condition affecting a network supporting a plurality of communication services, detecting an attempt to access at least one of the plurality of communication services, and issuing an alert of the network service condition. The attempted access can be detected by an optical network terminal, and the plurality of communication services can include voice, video, and data services. The network service condition can also be detected by the optical network terminal.

According to another example embodiment of the invention, the network includes at least one communication terminal and a network element communicatively coupled to the communication terminal. The network element detects an attempt to access at least one of the plurality of communication services of the network and alerts the user to a condition affecting the network. The network element can also detect the condition.

According to another example embodiment of the invention, the network element operating in the communications network comprises a communications interface coupled to the network, a storage device arranged to store program instructions, and a processor coupled to the communication interface and the storage device, and operating under the control of the program instructions. The program instructions contain instructions for detecting an attempt to access at least one of the plurality of communication services and for issuing an alert of a network service condition. The program instructions can also contain instructions for detecting the network service condition.

According to yet another example embodiment of the invention, the computer program includes code to detect an attempt to access at least one of the plurality of communication services and issue an alert of a network service condition. The computer program can also include code to control a network element to detect the network service condition.

Further features and advantages, as well as the structure and operation, of various example embodiments of the present invention are described in detail below with reference to the accompanying drawings.

### BRIEF DESCRIPTION OF THE DRAWINGS

FIG. 1 is a diagram of an example communications network.

FIG. 2 is a diagram of an example data processing architecture.

FIG. 3 shows a block diagram of a method in accordance with one aspect of an example embodiment of the invention.

FIG. 4 shows a block diagram of a method in accordance with another aspect of an example embodiment of the invention

FIG. 5 shows a table of example network conditions and messages which may reflect one or more example embodiments of the invention.

FIG. 6 shows a simplified network diagram for managing the detection and alerting of network service conditions, in accordance with an example embodiment of the invention.

FIG. 7 is a logical diagram of a circuit device in accordance with an example embodiment of the invention.

### DETAILED DESCRIPTION

Those skilled in the art will appreciate that, as used herein, an optical network terminal (ONT) can be other network elements, for example, optical network units (ONUs) remote digital terminals (RDTs), or any other user node.

Furthermore, as used herein, the term “user” can refer to service provider customers, purchasers of network service, or any other entity which may manage, process, or otherwise interact with information via a network service.

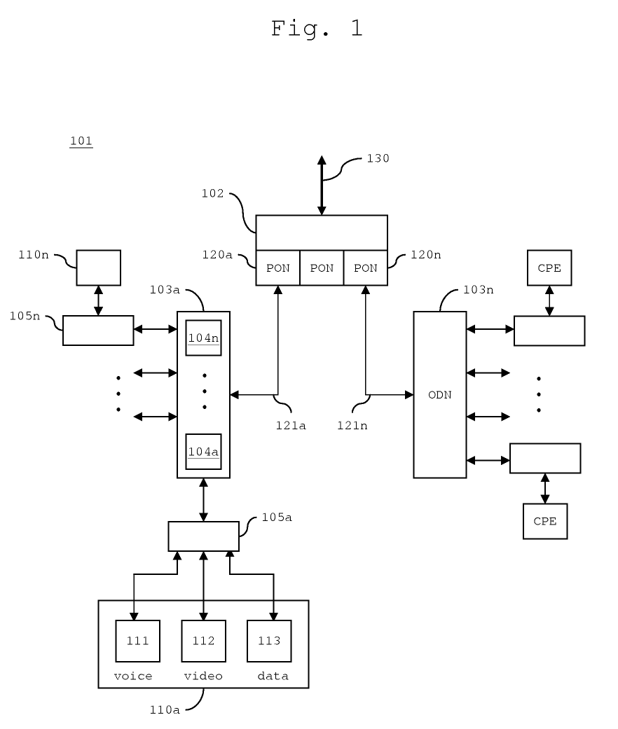

FIG. 1 is a network diagram of an example communication system or network, which may be a detailed version of the PON described above, and which may be used in conjunction with one or more example embodiments. A passive optical network (PON) 101 includes an optical line terminal (OLT) 102, optical distribution network (ODN) devices 103a-n, ODN device splitters 104a-n, optical network terminals (ONTs) 105a-n, and customer premises equipment (CPE) 110a-n. The OLT 102 couples the PON 101 with a wider backbone network of external services through uplink 130. The OLT 102 includes PON cards 120a-n, each of which provides a corresponding optical feed 121a-n to ODN devices 103a-n. For example, optical feed 121a is distributed through corresponding ODN device 103a by separate ODN device splitters 104a-n to respective ONTs 105a-n.

The PON 101 may be deployed for FTTx applications, for example. The optical feeds 121a-n in PON 101 may operate at bandwidths such as 155 Mbit/s, 622 Mbit/s, 1.25 Gbit/s, and 2.5 Gbit/sec, or any other desired bandwidth. The PON 101 may incorporate such communications standards as, for example, asynchronous transfer mode PON (APON), broadband PON (BPON), Gigabit PON (GPON) communications, Ethernet PON (EPON) communications, and 10 Gigabit Ethernet PON (10GEPON).

The ONTs 105a-n of PON 101 are the user access equipment through which customer premises equipment (CPE) 110a-n receive communications from and transmit communications to OLT 102 along optical path 121a. At ONTs 105a-n, optical signals originating from OLT 102 can be converted into electrical signals for use by CPE 110a-n. Similarly, electrical signals originating from CPE 110a-n may be converted into optical signals by ONTs 105a-n. ONTs 105a-n support various network services including, for example, voice, data, and video. ONTs 105a-n can include support for both digital Voice over Internet Protocol (VoIP) and analog public switched telephone network (PSTN) services, although support for other services also can be provided. ONTs 105a-n can provide an analog interface for VoIP services via a subscriber line integrated circuit (SLIC), such that a user can access voice services with a standard analog telephone, and can also provide an interface for broadband digital telephones. Support for caller ID generation via frequency key shifting (FSK) may also be provided. ONTs 105a-n can support data communications via interfaces including, for example, 10 BaseT, 100 BaseT, 1000 BaseT, MoCA, and HomePNA. ONTs 105a-n can further provide coaxial analog video interfaces, as well as digital video interfaces supporting video communications such as switched digital video (SDV) and internet protocol television (IPTV).

CPE 110a-n are customer communication terminals, which can receive and provide communications in the PON 101 through ONTs 105a-n. CPE 110a-n may include analog PSTN and digital broadband telephones 111, video devices 112, and computer terminals 113, as well as portable computer docking nodes, web-based television units, personal digital assistants and palmtop computers, digital subscriber line (DSL) and cable modems, wireless access terminals, as well as any other type of communication terminal.

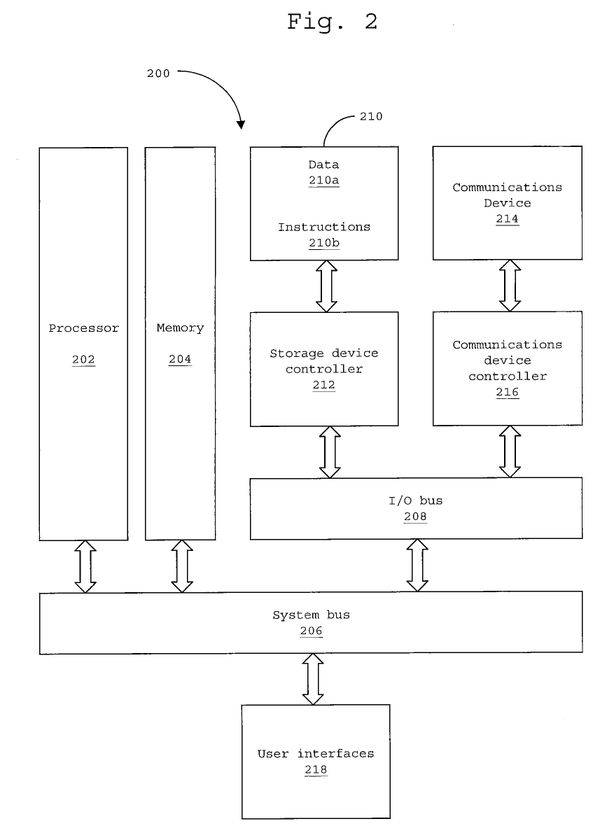

FIG. 2 is a diagram of an example data processing system which, according to an example embodiment of the invention, can be incorporated into, for example, ONTs 105a-n, OLT 102, ODN devices 103a-n, ODN device splitters 104a-n, and CPE 110a-n of FIG. 1. Data processing system 200 includes a processor 202 coupled to a memory 204 via a system bus 206. The processor 202 is also coupled to external devices (not shown) via the system bus 206 and an input/output (I/O) bus 208, and at least one user interface 218. The processor 202 may be further coupled to a communications device 214 via a communications device controller 216 coupled to the I/O bus 208. The processor 202 uses the communications device 214 to communicate with a network such as, for example, the network shown in FIG. 1, and the communications device 214 may have one or more I/O ports. Processor 202 also can include an internal clock (not shown) to keep track of time and periodic time intervals. The user interface 218 may include, for example, at least one of a keyboard, mouse, trackball, touch screen, keypad, or any other suitable user-operable input device, and at least one of a video display, speaker, printer, or any other suitable output device enabling a user to receive outputted information.

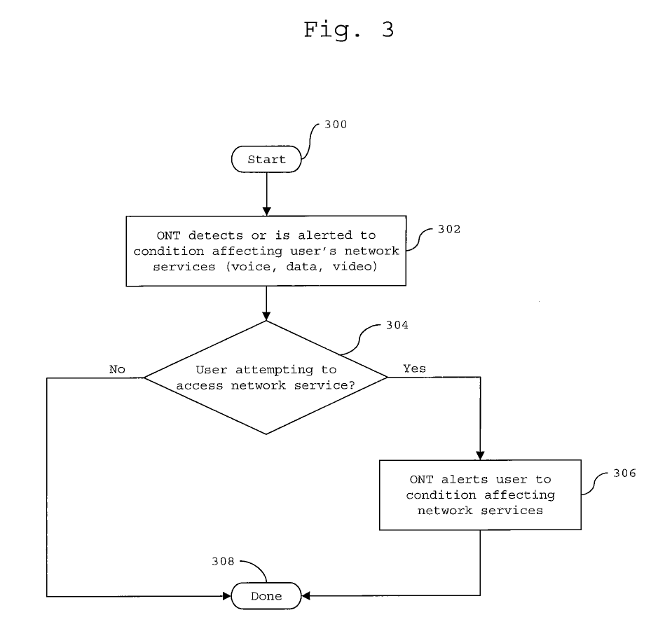

A storage device 210 having a computer-readable medium is coupled to the processor 202 via a storage device controller 212, the I/O bus 208 and the system bus 206. The storage device 210 is used by the processor 202 and storage device controller 212 to read and write data 210a, and to store program instructions 210b. Alternately, program instructions 210b can be stored directly in non-volatile or volatile portions of memory 204. Program instructions 210b may be used to implement the procedure described below in connection with FIGS. 3-5.

The storage device 210 can also stores various routines and operating systems, such as Microsoft Windows, UNIX, and LINUX, that can be used by the processor 202 for controlling the operation of system 200. At least one of the operating systems stored in storage device 210 can include the TCP/IP protocol stack for implementing a known method for connecting to the Internet or another network, and can also include web browser software for enabling a user of the system 200 to navigate or otherwise exchange information with the World Wide Web. Additionally the storage device can store audio codecs for encoding and decoding digital audio formats including, for example, WAV, MPEG Layer-3, and Windows Media Audio, and can store video codecs for encoding and decoding digital video formats including, for example, MPEG-4 and Windows Media Video.

In operation, the processor 202 loads the program instructions 210b from the storage device 210 into the memory 204. The processor 202 then executes the loaded program instructions 210b to perform any example methods described below for operating the system 200.

In the case of ONTs 105a-n, the program instructions 210b also include instructions which, when executed by the processor 202, can enable the ONT to issue alerts of detected network service conditions. The alerts can be communicated to a user via at least the user interface 218 and forwarded via communications device 214 to another destination such as, for example, CPE 110a-n, another ONT 105a-n, and OLT 102. The program instructions 210b also can enable the ONTs 105a-n to request, receive, and process detections originating from another device and to correlate the detection of a condition with the specific network service, e.g., data, video, and voice, for which the detection was made.

FIG. 3 shows a method in accordance with an example embodiment of the invention. Starting from block 300, at block 302 a condition affecting one or more of a user's network services is detected. In an example embodiment of the invention, a user's ONT, e.g., ONT 105a in FIG. 1, can detect a network service condition through the monitoring of various physical and virtual interfaces, devices, and/or entities. Conditions that may be detected by the ONT can include, for example, faulty or missing batteries, hardware failures, or signal loss. In an example detection of hardware condition, the ONT can declare a low battery alarm when the battery backup unit (BBU) detects that the battery voltage has dropped below a threshold voltage for a predetermined period of time. In an example detection of a data loss condition, the ONT can declare a bit error rate (BER) alarm when the number of corrupted or dropped frames exceeds a predetermined threshold. In an example detection of a video service loss condition, the ONT can declare a video loss of signal (LOS) alarm when the received power of the video overlay signal falls below a certain threshold for a predetermined period of time. In an example detection of a voice service loss condition, the ONT can declare an alarm if it does not receives an internet protocol (IP) address for VoIP service after a predetermined number of attempts. In the foregoing examples, detection can occur according to standards defined by, for example, industry organizations (e.g., FSAN, ITU, and IEEE), manufacturers of components comprising the ONT or other network elements, and the network service provider.

In another example embodiment of the invention, a condition affecting a user's network service can be detected by a network element other than a user's ONT. For instance, a condition can be detected by upstream network elements, e.g., OLT 102 or ODN device 103a, both of FIG. 1. In this instance, the condition is detected by the other network element, which then alerts the user's ONT to the condition. A general description of the detection and communication of service-affecting conditions by network elements is set forth in U.S. patent application Ser. No. 11/833,699, which is hereby incorporated by reference as if fully set forth herein.

Following the detection of a condition, at block 304 a user's attempt to access one or more network services is detected. In one example embodiment of the invention, the user's ONT detects whether the user is attempting to access the voice service. An attempt to access the voice service can be detected by the ONT when, for example, the user's telephone has been taken off-hook. If the telephone has been taken off-hook, the method proceeds to block 306. Conversely, if the user's telephone has not been taken off-hook, which may occur if, for example, the user is not at home or the user is not using any of the subscribed network services, the method terminates at block 308, and the ONT does not alert the user to the detected condition.

In another example embodiment of the invention, the ONT can also detect a user's attempt to access video and/or data services. To detect an attempt to access the data service, the user's ONT can include hardware or software capable of “packet sniffing,” whereby the ONT can log and analyze data sent to and from the ONT. The ONT can be further programmed to scan the network traffic for predetermined patterns indicating the use by a user of one or more communication terminals, e.g., CPE 110 of FIG. 1. The detection of one or more of these patterns can be interpreted by the ONT as an attempt by a user to access the data service. Similarly, the ONT can inspect traffic on the video service for predetermined patterns indicating user access, e.g., channel change requests and network traffic indicating that a user has attempted to access a program guide feature on a video device.

At block 306, the ONT alerts the user to the condition affecting the user's network service. Because block 306 is reached only when a user has attempted to access the network service, a user is not unnecessarily alerted, as they are when an autodialer technology is used. Also, because users are informed of the condition by the ONT, users need not call the service provider's customer support, requiring the service provider's OSS to remotely diagnose alarm telemetry information. Thus, the number of calls to the support system is reduced, the burden on the OSS of diagnosing conditions local to the user's equipment is relaxed, and real-time feedback to the user is provided.

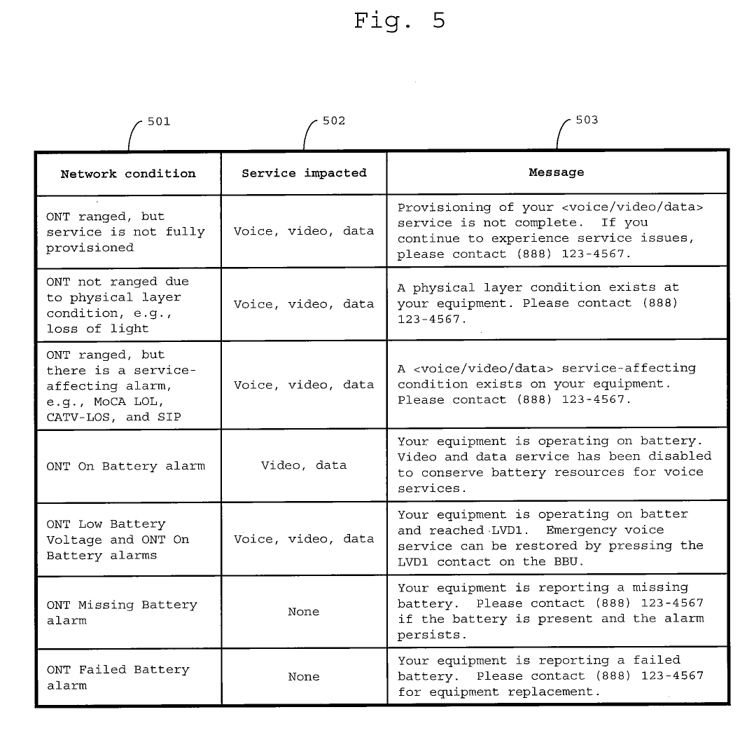

In an example embodiment of the invention, the ONT alerts a user of a condition by playing at least one prerecorded message when the phone is taken off-hook. In this embodiment, the ONT is programmed with and stores at least one prerecorded message, which may be in any analog or digital audio format. In connection with FIG. 5 (discussed in further detail below), a prerecorded message can correspond to and identify one or more conditions affecting the network service. When the ONT detects that a condition affecting network service is present and the user's telephone is off-hook, the ONT plays a prerecorded message corresponding to the condition or conditions to which the user should be alerted. The playback by the ONT can be provided in lieu of or prior to a dial tone.

In another example embodiment, the ONT can be further programmed to send a distinct dial tone when a condition is detected. The distinct dial tone can be, for example, a stuttered dial tone or any other secondary dial tone. In this embodiment, when the telephone is taken-off hook, rather than automatically playing a prerecorded message, the distinct tone pattern is provided. In this manner, the user is informed that there is a condition affecting the user's network service. The user can then enter a sequence on the keypad in order to access the message through, for instance, a voicemail interface. Alternatively, the user can enter a different predetermined sequence on the keypad in order to ignore the alert. The user may choose to ignore the alert if, for example, the user wishes to immediately use the telephone for a personal or non-network-related reason, or wishes to immediately contact the network OSS prior to being alerted to the condition. The user may also enter a combination via the keypad to specify that future alerts be provided via a caller ID interface on the user's telephone.

In another example embodiment of the invention, the user can be alerted by communications via the video or data services, in addition to communications via the voice service as described above in the foregoing embodiments. Alerts via the video or data services may useful in, but not limited to, instances when a user has attempted to access the corresponding video or data service. An alert on a communication terminal utilizing the data service, e.g., computer terminal 113 of FIG. 1, can be made by, for example, the redirection of a data request from the computer terminal to a local HTTP server controlled by the ONT. In this example, the user can be redirected to a web page where the condition can be communicated to the user. The condition may be communicated to the user by displaying a message, examples of which include messages 503 of FIG. 5 below. The web page may also include other information and user-selectable options similar to those discussed above in connection with alerting users via a voicemail interface. For example, from the web page the user can have access to features allowing the modification and creation of alert settings, as well as the uploading of data to and downloading of data from the ONT.

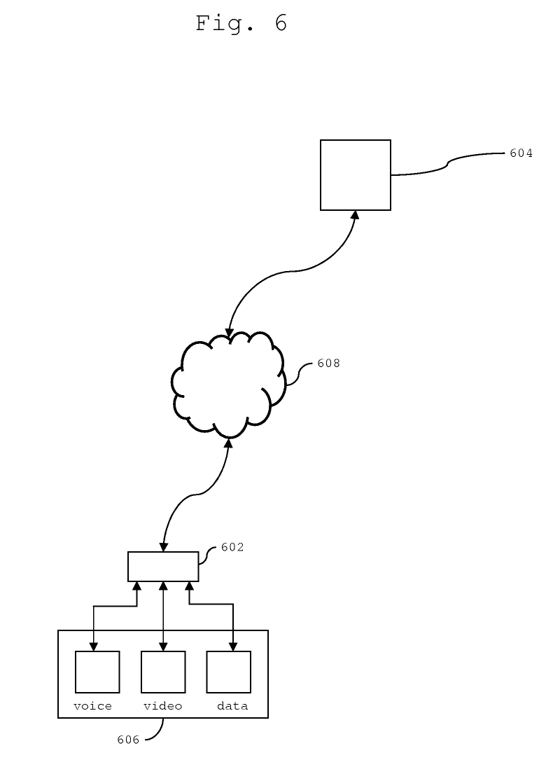

Similarly, alerts can be made on communication terminals utilizing the video service, e.g., video device 112 of FIG. 1. For example, the ONT can transmit a channel change request to the video device, causing the video device to display a specific diagnostic channel over which the alert can be communicated. In this example, the diagnostic channel can communicate to the user information regarding the performance and status of the network service and network elements. On this channel the ONT can display, for example, prerecorded images, sounds, or movies stored on or accessible to the ONT, as described above in connection with FIG. 1 and below in connection with FIG. 6, as well as informative messages, e.g., messages 503 of FIG. 5 below. As another example of alerting via the video service, if a video device is coupled to the video service by a set-top box (STB), e.g., a cable converter or an integrated receiver/decoder (IRD), the ONT can transmit an instruction to the STB to display an specific channel, alerting screen or other informative display. If the STB is capable of caller ID notification, the ONT can also transmit information to the STB via the caller ID interface. In this example, the user can read the transmitted information in the caller ID field of the STB and be alerted to a network condition. As yet another example of alerting via the video service, the ONT can embed messages, e.g., messages 503 of FIG. 5 below, or other information into the media stream transmitted to the video device, such that a user can be alerted to the network condition by the display of the embedded information.

In yet another embodiment of the invention, a user can be alerted to a condition affecting network service by LEDs or other service lights present on an ONT. In this embodiment, one or more lights on the exterior case of the ONT, or any user-accessible portion thereof, may be turned on, turned off, set to blink in a particular manner, or set at a particular color in response to the detection of the condition. The lights may have corresponding text printed at or near the light housing allowing the user to interpret the meaning of the light display, thereby alerting the user to the nature of the condition. Similarly, a user manual or other printed or digital reference can allow users to correspond the light display at the ONT with a particular network service condition. Such a reference may include, for example, messages 503 of FIG. 5 below.

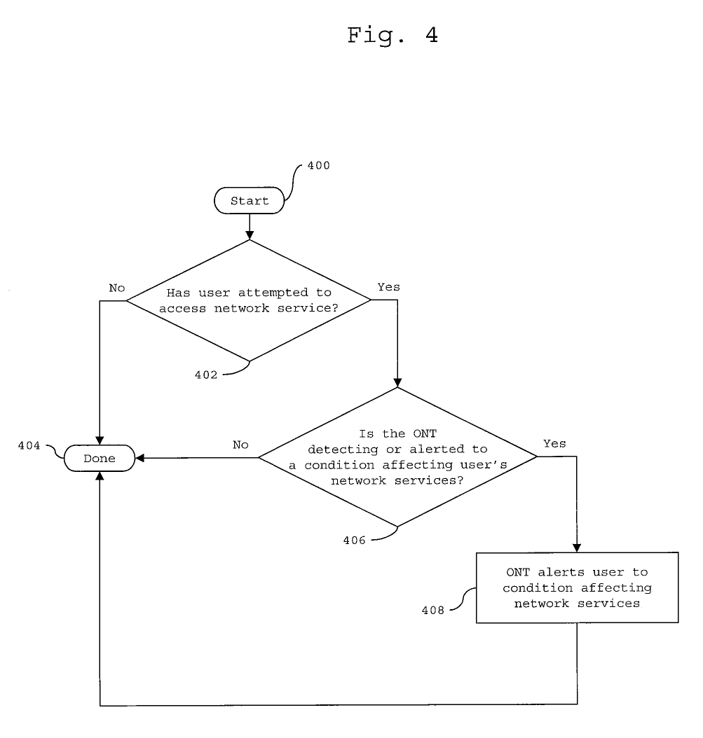

The method shown in FIG. 3 is highly flexible and configurable. For example, the ONT can detect a condition after the user has attempted to access a network service, as shown in FIG. 4. Starting at block 400, in decision block 402, the user may have attempted to access a network service. An attempt to access network service may be detected when, for example, the user's telephone has been taken off-hook, a program guide for the video service is requested, or a predetermined pattern is detected in the network traffic of the data service. If an attempt to access network service is not detected, the method terminates at block 404. If an attempt is detected, at block 406 the ONT then checks for conditions affecting the user's network service, e.g., an error in provisioning the ONT or a loss of main power. Checking for conditions may include, for example, running detection routines and receiving alerts for conditions detected by other network elements. If any such condition is detected, the ONT then alerts the customer to the condition at block 408. If no condition is detected but the user has attempted to access a network service, the method terminates at block 404. Because an ONT can quickly and efficiently detect service-affecting conditions and receive detection alerts from other network elements, from a user's perspective the time between an attempted access and a decision being made at block 406 is nearly instantaneous. Thus, the method described by FIG. 4 can be run transparently and without a user's awareness, unless, of course, a condition is detected to which a user should be alerted.

As a further example, the methods of FIG. 3 and FIG. 4 may be run on a continuous basis, in which the termination of one sequence initiates a new sequence. In connection with a continuous method, a condition detected in a prior sequence may be ignored based upon a predetermined algorithm or set of instructions directing the ignoring of conditions. For instance, if the ONT detects that the ONT is operating on backup battery power, but thereafter continuously detects for a predetermined time interval, e.g., 10 seconds, that the ONT is not operating on battery power, e.g., the main power has been restored, then the user need not be notified. This scenario may occur and can be useful when, for example, power to the ONT goes out while the network service is not in use by any CPE. If the power is restored prior to the user's use of the CPE and the network service, the user need not be informed that a condition affecting the user's network service was previously present.

The foregoing examples are given simply to highlight the flexibility of the methods outlined in FIGS. 3-4, and in no way should be construed as limiting the manner in which the example embodiments as described herein are practiced.

FIG. 5 shows a table of example network conditions 501, as well the network service(s) 502 impacted by the conditions, and example messages 503 corresponding to each network condition, all of which may reflect one or more example embodiments of the invention. Messages 503 alert users to network service conditions, and can be contained in text, audio recording, still images, or video recordings. In at least one example embodiment, the network conditions 501 are local to the user's access equipment, i.e., between and including an ONT (e.g., 105a) and CPE (e.g., 110a) in FIG. 1. The network conditions 501 may be detectable by the ONT or by other network elements. The conditions 501 may be detected in blocks 302 and 406 of FIGS. 3 and 4, respectively, as affecting the associated services 502. The messages 503 can be pre-recorded and pre-programmed onto the user's ONT, as described above in connection with FIG. 3 above, and can be provided to user CPE in blocks 306 and 410, as described above.

Some network conditions 501 may not have an immediate impact on any network service, yet may generally be considered to affect network service. For example, the condition “ONT Missing Battery alarm” may not result in a loss of any network service, because as long as the ONT is operating on its main power supply, no network service will be lost. However, the condition is one that can affect a user's network service: if the main power is lost, there will be no battery backup, and the user will lose all network services. Thus, some of the conditions that the ONT reports to the user may not result in the present loss of any network service.

The individual conditions, services impacted, and messages listed in the table of FIG. 5 simply serve as examples; a user's ONT can be programmed to detect a broad range of conditions affecting a user's network services, and, moreover, one or more messages could correspond to and be generated in response to a detected condition. In one example embodiment, if a condition has been detected for a predetermined period of time, a different message can be provided in response thereto than if the condition had only recently been detected or detected for a lesser amount of time. In another example embodiment, a user's ONT can be programmed to correlate multiple alarms, resulting in a different message than the messages corresponding to the individual alarms. For example, consider the detection of two network service conditions: a loss of main power and a loss of video signal. The loss of main power results in the disabling of the video service, but even if the main power is restored, the video service may not be operable due to the loss of video signal. Thus, the ONT can correlate the two alarms and alert that the user that the video service is temporarily down due to the loss of main power, and the service provider should be contacted if the video is not restored after main power is restored.

FIG. 6 shows a simplified network diagram for managing the detection and alerting of conditions affecting network service. ONT 602 is connected to network OSS 604 through network 608, and is further connected to CPE 606. ONT 602 and CPE 606 may be ONTs 205a-n and CPE 210a-n of FIG. 1, respectively. Network 608 may represent any FTTx network, including PON 101 of FIG. 1. OSS 604 can access the hardware and software of ONT 602 through network 608. In this manner, OSS 604 can program, reprogram, update, or otherwise alter the routines, operating systems, firmware, and stored data of ONT 602. For example, OSS 604 can send to ONT 602 program code which adds new condition-detection or user access-detection capabilities. As another example, OSS 604 can also send sound, picture, and video recordings to be stored on ONT 602. Because OSS 064 can be connected to many ONTs (not shown) through network 608, the OSS can simultaneously update or change the capabilities of many users' ONTs.

Similarly, CPE 606 can be used to modify the capabilities of ONT 602. A user can access ONT 602 through one or more communication terminals to alter settings for the detection and alerting of conditions. In an example embodiment of the invention, a user may also alter ONT 602 in any manner described in connection with OSS 604. In another example embodiment, a user does not have the same access to the ONT 602 as OSS 604, but the user can add or manage sounds, pictures, and video stored on ONT 602.

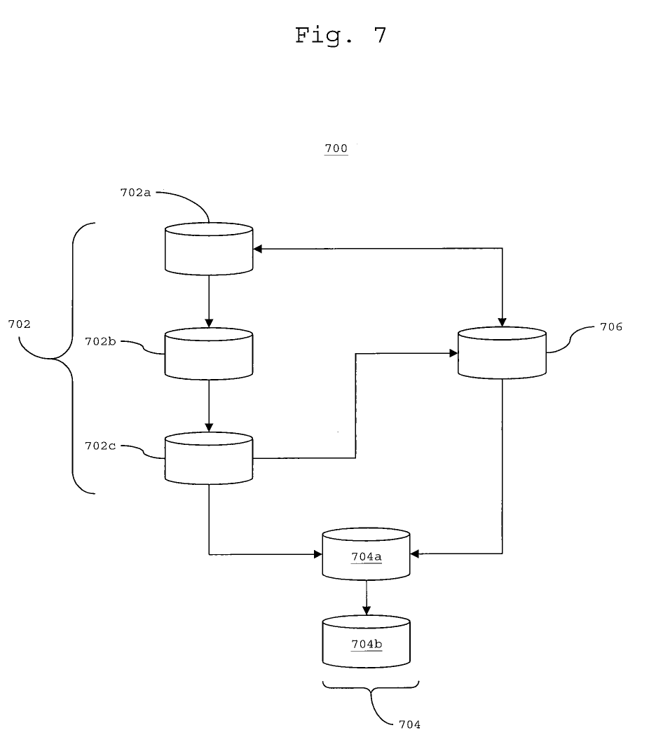

FIG. 7 illustrates a logical diagram 700 of the modules of an example network system or similarly organized circuit devices such as, for example, application-specific integrated circuits (ASICs) or field-programmable gate arrays (FPGAs), which could be used as network elements, e.g., OLT 102 and ONTs 105a-n of FIG. 1, in accordance with one or more example embodiments of the present invention. The modules may include hardware circuitry, software, and/or combinations thereof. In an example embodiment, software routines for performing the modules depicted in logical diagram 700 can be stored as instructions 210b in a storage device 210 and executed by processor 202 of one or more data processing systems 200, as shown in FIG. 2. Logical diagram 700 includes a detection module 702 for detecting network service conditions as well as analyzing telemetry data, an alert module 704 for processing and notifying alerts, and a communication module 706 for directing information between detection module 702 and alert module 704, as well as sending data to and receiving data from other network elements and/or circuit devices.

The detection module 702 includes a sub-module 702a that detects, stores, and receives information such as alarm telemetry data in a network element, e.g. ONTs 105a-n of FIG. 1; a sub-module 702b arranged to analyze alarm telemetry data; and a sub-module 702c arranged to provide the analyzed information to other modules, e.g., alert module 704 and communication module 706.

The communication module 706 can send and receive unanalyzed alarm telemetry data from sub-module 702a. The communication module 706 can also send and receive analyzed alarm telemetry data from sub-module 702c.

The alert module 704 includes a sub-module 704a that can retrieve analyzed information from sub-module 402c or information from the communication module 706, and a presenter module 404b arranged to present retrieved analyzed information in a higher format to, for example, a user, as described above in connection with FIGS. 3-5.

By virtue of the example embodiments described herein, network users can be alerted to conditions affecting their network services. By providing alerts from the users' network access equipment, users can be informed of service-affecting issues in real time. Users are alerted when they are using their network services and the alerts do not require a user to contact a service provider's operational support system, thereby relieving the support system of the task of interpreting alarm telemetry and improving user satisfaction.

In the foregoing description, the present invention is described with reference to specific example embodiments. Despite these specific embodiments, many additional modification and variations would be apparent to those skilled in the art. Thus, it is to be understood that the invention may be practiced in a manner otherwise than as specifically described. Accordingly, the specification is to be regarded in an illustrative rather than restrictive fashion. It will be evident that modifications and changes may be made thereto without departing from the broader spirit and scope of the invention.

Similarly, it should be understood that the figures are presented solely for example purposes. The architecture of the example embodiments presented herein is sufficiently flexible and configurable such that it may be practiced (and navigated) in ways other than that shown in the accompanying figures.

Software embodiments of the example embodiments presented herein may be provided as a computer program product, or software, that may include an article of manufacture on a machine-accessible or machine-readable medium having instructions. The instructions on the machine-accessible or machine-readable medium may be used to program a computer system or other electronic device. The machine-readable medium may include, but is not limited to, floppy diskettes, optical disks, CD-ROMs, and magneto-optical disks or other type of media suitable for storing or transmitting electronic instructions. The techniques described herein are not limited to any particular software configuration. They may find applicability in any computing or processing environment. As used herein, the terms “machine-accessible” or “machine-readable” shall include any medium capable of storing, encoding, or transmitting an instruction or sequence of instructions for execution by the machine such that the machine performs any one or more of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

Furthermore, the purpose of the foregoing abstract is to enable the U.S. Patent and Trademark Office, the general public, and scientists, engineers, and practitioners in the art who are unfamiliar with patent or legal terms or phrases, to quickly determine from a cursory inspection the nature and essence of the technical disclosure of the application. The abstract is not intended to limit the scope of the present invention in any way. It is also to be understood that the processes recited in the claims need not be performed in the order presented.

What is claimed is:

1. A method for alerting users to network service conditions, comprising:
detecting a network service condition affecting a network supporting a plurality of communication services;
detecting an attempt to access at least one of the plurality of communication services; and
issuing an alert of the network service condition.

2. The method of claim 1, wherein the attempt is detected by an optical network terminal.

3. The method of claim 2, wherein the network service condition is detected by the optical network terminal.

4. The method of claim 3, wherein the network service condition is local to the optical network terminal.

5. The method of claim 1, wherein the plurality of communication services include one or more of voice, video, and data services.

6. The method of claim 5, wherein the alert is a communication on at least one of the plurality of communications services.

7. A communications network, comprising:
at least one communication terminal; and
a network element communicatively coupled to the least one communication terminal,
wherein the network element is arranged to detect an attempt to access at least one of a plurality of communication services supported by a network, and issue an alert of a network service condition affecting the network.

8. The network of claim 7, wherein the network element is further arranged to detect the network service condition.

9. The network of claim 8, wherein the network service condition is local to an optical network terminal.

10. The network of claim 9, wherein the network element is the optical network terminal.

11. The network of claim 7, wherein the plurality of communication services include one or more of voice, video, and data services.

12. The network of claim 11, wherein the alert is a communication on at least one of the plurality of communication services.

13. A network element operating in a communications network, the element comprising:
a communications interface coupled to a network comprised of a plurality of communication services;
a storage device arranged to store program instructions; and
a processor coupled to the communication interface and the storage device, and operating under the control of the program instructions to communicate with the network through the communications interface,
wherein the program instructions contain instructions for detecting an attempt to access at least one of the plurality of communication services, and instructions for issuing an alert of a network service condition affecting the network.

14. The network element of claim 13, wherein the program instructions further contain instructions for detecting the network service condition.

15. The network element of claim 14, wherein the network service condition is local to the network element.

16. The network element of claim 15, wherein the network element is an optical network terminal.

17. The network element of claim 14, wherein the plurality of communication services include one or more of voice, video, and data services.

18. The network element of claim 17, wherein the alert is a communication on at least one of the plurality of communications services.

19. A computer program embodied in a computer-readable storage medium, the program comprising code to control a network element to:
detect an attempt to access at least one of a plurality of communication services supported by a network; and
issue an alert of a network service condition affecting the network.

20. The computer program of claim 19, further comprising code to control a network element to detect the network service condition.

21. The computer program of claim 20, wherein the attempt is detected by an optical network terminal.

22. The computer program of claim 21, wherein the network service condition is local to the optical network terminal.

23. The computer program of claim 22, wherein the network service condition is detected by the optical network terminal.

24. The computer program of claim 19, wherein the plurality of communication services include one or more of voice, video, and data services.

25. The computer program of claim 24, wherein the alert is a communication on at least one of the plurality of communication services.
